(19) United States
(12) Patent Application Publication
(10) Pub. No.: US 2023/0227051 A1
(43) Pub. Date: Jul. 20, 2023

(54) ZONE CONTROL UNIT FOR A VEHICLE

(71) Applicant: ZF Friedrichshafen AG, Friedrichshafen (DE)

(72) Inventors: Timm MUNTEL, Friedrichshafen (DE); Istvan HEGEDÜS-BITE, Eriskirch (DE); IIker BAGCI, Ravensburg (DE); Mohammad ALSHARIF, Tettnang (DE); Hubert BICHELMEIER, Tettnang (DE); Bastian HUBRACHT, Salem (DE); Gowtham PERUMALSAMY, Markdorf (DE)

(73) Assignee: ZF Friedrichshafen AG, Friedrichshafen (DE)

(21) Appl. No.: 18/155,539

(22) Filed: Jan. 17, 2023

(30) Foreign Application Priority Data
Jan. 19, 2022 (DE) 102022200581.3

(51) Int. Cl. B60W 50/02; G07C 5/08; B60W 40/10

(52) U.S. Cl. CPC B60W 50/0205; G07C 5/0808; B60W 40/10; B60W 2556/35

(57) ABSTRACT

A vehicle includes a plurality of zone control units that each comprise an inertial measurement unit, and wherein each zone control unit is configured to provide inertial measurement data obtained from its respective inertial measurement unit to other vehicle components via a vehicle bus.

### CROSS-REFERENCE TO RELATED APPLICATION

This application claims priority to German Application No. DE 10 2022 200 581.3, filed on Jan. 19, 2022, the entirety of which is hereby fully incorporated by reference herein.

### TECHNICAL FIELD

The present disclosure relates to a zone control unit for a vehicle. The invention also relates to a vehicle, a method, a computer program, and a machine-readable medium according to the present disclosure.

### BACKGROUND

Modern vehicles typically comprise numerous sensors. By way of example, modern vehicles typically comprise so-called inertial measurement units (also referred to as IMUs). These inertial measurement units are devices that typically comprise a spatial combination of numerous so-called inertial sensors. Examples of these inertial sensors are accelerometers and angular rate sensors.

Data from inertial measurement units are used to verify vehicle motion, for example. By way of example, drivers are frequently assisted these days by a so-called electronic stability program (ESP). An ESP typically uses the rotational rates of the individual wheels, the steering angle of the vehicle, and data from the inertial measurement unit to determine deviations between a desired trajectory of the vehicle and the actual trajectory. If there is a deviation between the desired and actual trajectories, the vehicle movement is corrected with ESP through braking processes.

The inertial measurement unit is typically placed at the center of gravity in a vehicle, e.g. in an airbag control unit or as a separate sensor unit.

As electric vehicles are becoming more significant, it is often no longer possible to place to inertial measurement unit at the center of gravity of the vehicle due to the battery design. When it is placed outside the center of gravity, however, the inertial measurement unit displaces the center of gravity, resulting in displacement errors in the data from the inertial measurement unit.

### SUMMARY

An object of the invention is to eliminate or at least diminish the disadvantages in the prior art.

This object is achieved with a zone control unit for a vehicle in which the zone control unit comprises an inertial measurement unit. The invention is based on the fact that with modern vehicles, so-called zone control units are frequently used instead of a single vehicle control system, and are therefore distributed spatially over the vehicle, thus offering the possibility of integrating inertial measurement units. A zone control unit of this type solves the problem addressed by the object in that the inertial measurement unit can be placed at a specific, well-known location in the vehicle, specifically as part of a zone control unit. The term “zone control unit” is to be understood to mean a control unit in particular that is placed in a specific zone in a vehicle, e.g. at the rear wheel on the right or left side, or in the front end of the vehicle, and which assumes control functions for vehicle components located in its respective zone. Typical embodiments of the zone control unit comprise a printed circuit board, which in turn comprises the inertial measurement unit. It is also possible for the inertial measurement unit to be placed on a housing for the zone control unit, instead of directly on the printed circuit board in the zone control unit.

The object is also achieved with a vehicle that comprises at least one zone control unit, preferably at least two zone control units, advantageously at least three zone control units, and particularly preferably four, five, six, or more zone control units according to the invention, where each zone control unit can advantageously provide the inertial measurement data from its own inertial measurement unit to other vehicle components, preferably via a vehicle bus. The term, “other vehicle components,” refers not only to vehicle control units such as central vehicle control units, control units for autonomous, semiautonomous or assisted driving, but also to other data processing elements in the vehicle. The term, “vehicle bus” refers in particular to a vehicle bus system for data communication between individual components in the vehicle. In typical embodiments, there are no zone control units in the vehicle's center of gravity. The distance between each zone control unit and the vehicle's center of gravity is typically at least 0.5 meters, preferably at least 0.75 meters, and advantageously at least 1 meter. In an advantageous embodiment, the vehicle is an electric vehicle, e.g. an electric passenger automobile, electric truck, or an electric bus.

In advantageous embodiments, the vehicle comprises numerous zone control units that are spatially distributed over the vehicle, in particular such that at least a portion of the zone control units are distributed symmetrically over the vehicle. In advantageous embodiments, the zone control units are distributed symmetrically in relation to the longitudinal axis of the vehicle and/or the lateral axis of the vehicle, and they may also be distributed symmetrically in relation to the vehicle's center of gravity. In advantageous embodiments, the vehicle comprises a zone control unit near a rear wheel on the right side of the vehicle. This embodiment also typically comprises a zone control unit near a rear wheel on the left side of the vehicle. Typical embodiments comprise a zone control unit in the front end of the vehicle. Advantageous embodiments comprise a zone control unit near the right front wheel of the vehicle. Typical embodiments comprise a zone control unit near the left front wheel of the vehicle. One advantage in using the numerous zone control units provided by the invention in a vehicle is the fact that this allows data to be acquired from numerous inertial measurement units, such that it is possible to estimate displacement errors resulting from the inertial measurement units not being located in the vehicle's center of gravity.

Advantageous embodiments of the vehicle enable generation of an inertial measurement data fusion. An “inertial measurement data fusion” is understood to mean a combination of inertial measurement data compiled by the individual zone control units. Inertial measurement data from different zone control units are combined in this case to obtain what is referred to as the “inertial measurement data fusion.” This inertial measurement data fusion can comprise mean values for the inertial measurement data for example. In other words, the inertial measurement data fusion in typical embodiments is a set of mean inertial measurement data and/or a combination of the individual inertial measurement data from the individual inertial measurement data units in the individual zone control units. Generating an inertial measurement data fusion in this manner has the advantage that disrupting values resulting from the displacement of the individual zone control units in relation to the vehicle's center of gravity can be eliminated from or averaged out of the inertial measurement data obtained from the individual zone control units. Advantageous embodiments of the vehicle comprise an inertial measurement data fusion generator, which is implemented advantageously at least in part with computer program code.

In advantageous embodiments, the vehicle is able to calculate a dynamic vehicle behavior, and/or detect a malfunctioning of the vehicle and/or a vehicle component and/or a zone control unit and/or a zone control unit element and/or an inertial measurement unit. In typical embodiments, the calculation of the dynamic vehicle behavior comprises comparison of a desired trajectory of the vehicle with an actual trajectory in which the comparison is advantageously obtained using a vehicle model. In advantageous embodiments, a “2 out of 3” method is used for detecting malfunctions, in particular a method in which a so-called “2 out of 3” voting system is used. In typical embodiments, the vehicle comprises an evaluation logic system for an M out of N processing in accordance with the IEC 61508 standard, in particular a 2 out of 3 evaluation logic system.

The object is also achieved with a method for obtaining inertial measurement data in a vehicle according to any of the above exemplary embodiments in which the method comprises the following steps: querying inertial measurement data, in which current inertial measurement data are queried from at least one zone control unit, preferably all zone control units in the vehicle, and providing inertial measurement data, in which the current inertial measurement data are sent to at least one other vehicle component, preferably via the vehicle bus. The step in which the inertial measurement data are queried, and/or the step in which the inertial measurement data are provided are preferably carried out continuously in a loop, and can therefore be referred to as processes. The processes take place simultaneously in advantageous embodiments, at least in part. The term, “other vehicle components,” is to be understood as explained above in reference to the vehicle. Provision of the inertial measurement data via a vehicle bus has the advantage that latencies can be minimized, in particular in cases where the initial measurement units are integrated on the printed circuit boards in the zone control units.

Advantageous embodiments of the method comprise an inertial measurement data fusion step in which inertial measurement data fusion is obtained by combining inertial measurement data from different zone control units, preferably by combining inertial measurement data from all of the zone control units in the vehicle, in which the method preferably also comprises a step for selecting inertial measurement data in which inertial measurement data are selected from the inertial measurement data from the individual zone control units and/or the inertial measurement data fusion for further use in the vehicle and/or in a vehicle model. In other words, all of the inertial measurement data from the individual zone control units and the inertial measurement data fusion that has been generated are taken under consideration and/or compared to one another in the inertial measurement data selection step, and a measurement data dataset is subsequently selected for further use as selected inertial measurement data in the vehicle and/or a vehicle model. This has the advantage that, depending on the current situation and/or current purpose, particularly ideal inertial measurement data can be selected from all of the available inertial measurement data.

Advantageous embodiments of the method comprise a trajectory regulating step in which the inertial measurement data, and/or the inertial measurement data fusion, and/or the selected inertial measurement data, are used to regulate the vehicle's trajectory. In advantageous embodiments, a deviation between a desired trajectory and the actual trajectory of the vehicle is calculated in the trajectory regulating step. In advantageous embodiments, a braking procedure is subsequently or simultaneously carried out, at least in part on the basis of the results of the trajectory regulating step, using an ESP, possibly taking into account the wheel rotational rates and/or a steering angle that have been determined, such that the actual trajectory coincides as much as possible with the desired trajectory. In advantageous embodiments, it is verified in the trajectory regulating step whether a current driving dynamic corresponds to a desired driving dynamic. In advantageous embodiments, a vehicle model may be used in the trajectory regulating step, in which case the vehicle model is a computer model of the vehicle. Advantageous embodiments of the method comprise an error detection step in which a malfunctioning of the vehicle and/or a malfunctioning of vehicle components, and/or a malfunctioning of a zone control unit, and/or a malfunctioning of a zone control unit element, and/or a malfunctioning of an inertial measurement unit are detected on the basis of the inertial measurement data and/or the inertial measurement data fusion, and/or the selected inertial measurement data. Advantageous embodiments of the method comprise a displacement error calculation step in which a displacement error with regard to the vehicle's center of gravity is calculated on the basis of the inertial measurement data and/or the inertial measurement data fusion, and/or the selected inertial measurement data. Typical embodiments of the method comprise an artificial intelligence process in which one or more artificial intelligence methods are applied to at least one, preferably numerous, advantageously all of the steps in the method. Artificial intelligence methods can refer to machine learning, automatic search methods, automated planning methods, optimizing methods, and/or approximation methods.

In advantageous embodiments, a 2 out of 3 method is used in the trajectory regulating step and/or the error detection step, in particular a method in which a 2 out of 3 voting is used.

At least some of the above steps are carried out continuously in loops, and can therefore be referred to as processes. The processes are carried out simultaneously, at least in part, in advantageous embodiments.

A computer program comprises commands in one embodiment of the invention, with which the steps of the above method are carried out when the computer program is executed. The computer program can also be referred to as a computer program product.

A machine-readable medium comprises computer program code for carrying out the above method in one embodiment of the invention. The term, “machine-readable medium,” can refer to hard drives, and/or servers, and/or memory sticks, and/or flash drives, and/or DVDs, and/or Blu-ray discs, and/or CDs, etc. The term, “machine-readable medium,” can also refer to streaming data, such as that obtained when a computer program is downloaded from the internet.

### BRIEF DESCRIPTION OF THE DRAWINGS

The invention shall be explained in brief below in reference to the drawings, wherein:

FIG. 1 shows a schematic illustration of a vehicle according to various embodiments of the present disclosure, comprising three zone control units according to various embodiments of the present disclosure;

FIG. 2 shows a flow chart for a first embodiment of a method according to various embodiments of the present disclosure;

FIG. 3 shows a flow chart for a second embodiment of a method according to various embodiments of the present disclosure; and

FIG. 4 shows a flow chart for a third embodiment of a method according to various embodiments of the present disclosure.

### DETAILED DESCRIPTION

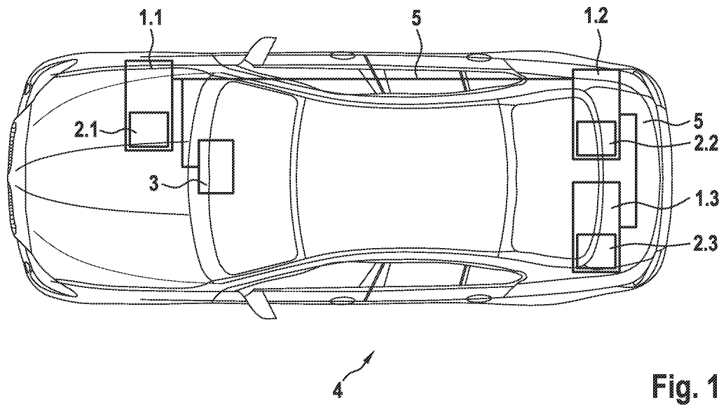

FIG. 1 shows a schematic illustration of a vehicle 4 according to the present disclosure, comprising three of the zone control units 1.1,1.2,1.3 as set forth in the present disclosure. The first zone control unit 1.1 comprises a first inertial measurement unit 2.1. The second zone control unit 1.2 comprises a second inertial measurement unit 2.2. the third zone control unit 1.3 comprises a third inertial measurement unit 2.3. The vehicle 4 also comprises a vehicle control system 3 that can be designed as an AD/ADAS control system. “AD” stands for “Autonomous Driving” and “ADAS” stands for “Advanced Driver Assistance System” here. The vehicle control system 3 and the zone control units 21.1,1.2, 1.3 are interconnected via a vehicle bus 5. Inertial measurement data obtained from the inertial measurement units 2.1, 2.2, 2.3 can thus be fed to vehicle bus 5 and then made available to the vehicle control system 3. The first zone control unit 1.1 is located in the front end of the vehicle 4, in particular near the front right wheel of the vehicle 4. The second zone control unit 1.2 is located in the rear end of the vehicle 4, in particular near a right rear wheel of the vehicle 4. The third zone control unit 1.3 is also in the rear end of the vehicle 4, in this case near the left rear wheel of the vehicle 4. The individual zones are not indicated in FIG. 1 for purposes of clarity.

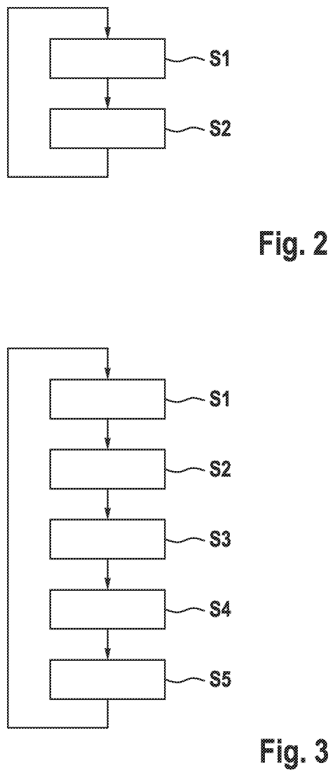

FIG. 2 shows a flow chart for a first embodiment of a method according to the present disclosure. The method in FIG. 2 shows an inertial measurement data query step S1 and an inertial measurement data provision step S2, which can both be carried out in a loop. Inertial measurement data are queried from inertial measurement units located in zone control units in a vehicle (such as that shown in FIG. 1, for example) in the inertial measurement data query step S1, in particular via a vehicle bus. These inertial measurement data are subsequently made available in the vehicle bus in the inertial measurement data provision step S2, such that other vehicle components such as control systems, sensors, or actuators can access them.

FIG. 3 shows a flow chart for a second embodiment of a method according to the present disclosure. The method in FIG. 3 shows the inertial measurement data query step S1, and the inertial measurement data provision step S2, which were shown in FIG. 2. The method in FIG. 3 also comprises an inertial measurement data fusion step S3, an inertial measurement data selection step S4, and a trajectory regulating step S5. An inertial measurement data fusion is generated in the inertial measurement data fusion step on the basis of the inertial measurement data obtained in the inertial measurement data provision step S2, which comprises a new inertial measurement data dataset that has been generated on the basis of the inertial measurement data from the individual zone control units. The inertial measurement data from the individual zone control units can also be referred to as “raw data.” A single inertial measurement data dataset is subsequently selected for further use in the inertial measurement data selection step S4 from the raw data and the inertial measurement data fusion. This selected inertial measurement data is then used in the trajectory regulating step S5 for regulating the trajectory of the vehicle in which the method shown in FIG. 3 is carried out. The method shown in FIG. 3 also runs in a loop, i.e. continuously.

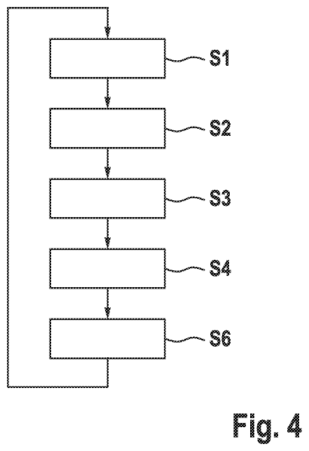

FIG. 4 shows a flow diagram for a third embodiment of a method according to the present disclosure. The method shown in FIG. 4 is very similar to the method shown in FIG. 3. Instead of the trajectory regulating step S5, however, the method in FIG. 4 comprises an error detection step S6. The selected inertial measurement data are used in this error detection step S6 to detect a malfunctioning of the vehicle and/or an incorrect regulation of the vehicle, and/or failure of a vehicle component. The method shown in FIG. 4 also runs continuously in the vehicle, as indicated by a loop in FIG. 4.

In principle, all of the exemplary embodiments and/or steps can be combined with one another unless this is otherwise technologically impossible.

The invention is not limited to the exemplary embodiments described herein. The scope of protection is defined by the claims.

In principle, all of the methods described in the description or the claims can be carried out by devices that comprise means for carrying out the respective steps of these methods.

### REFERENCE SYMBOLS

1.1, 1.2, 1.3 zone control units

2.1, 2.2, 2.3 inertial measurement units

3 vehicle control system (in particular AD/ADAS control systems)

4 vehicle

5 vehicle bus

1. A vehicle, comprising a plurality of zone control units, wherein each zone control unit comprises an inertial measurement unit, and wherein each zone control unit is configured to provide inertial measurement data obtained from its respective inertial measurement unit to other vehicle components via a vehicle bus.

2. The vehicle according to claim 1, wherein the plurality of zone control units are distributed spatially over the vehicle such that the plurality of zone control units are at least in part distributed symmetrically over the vehicle.

3. The vehicle according to claim 1, wherein the vehicle is configured to generate an inertial measurement data fusion.

4. The vehicle according to claim 1, wherein the vehicle is configured to calculate a dynamic vehicle behavior on a basis of the inertial measurement data and/or an inertial measurement data fusion generated by the vehicle.

5. The vehicle according to claim 1, wherein the vehicle is configured to detect a malfunctioning of the vehicle and/or a vehicle component, and/or a zone control unit, and/or a zone control unit element, and/or an inertial measurement unit, on a basis of the inertial measurement data and/or an inertial measurement data fusion generated by the vehicle.

6. A method comprising:
querying a plurality of zone control units in the vehicle for current inertial measurement data; and
providing the current inertial measurement data to at least one other vehicle component via a vehicle bus.

7. The method according to claim 6, comprising:
regulating a trajectory for the vehicle using the inertial measurement data.

8. The method according to claim 6, comprising:
detecting a malfunctioning of at least one of the vehicle, a malfunctioning of vehicle components, a malfunctioning of a zone control unit, a malfunctioning of a zone control unit element, and/or a malfunctioning of an inertial measurement unit on a basis of the inertial measurement data.

9. The method according to claim 6, comprising:
calculating a displacement error with regard to a vehicle's center of gravity on a basis of the inertial measurement data.

10. The method according to claim 6, comprising:
generating an inertial measurement data fusion from the current inertial measurement data from the plurality of zone control units.

11. The method according to claim 10, comprising:
regulating a trajectory for the vehicle using the inertial measurement data fusion.

12. The method according to claim 10, comprising:
detecting a malfunctioning of at least one of the vehicle, a malfunctioning of vehicle components, a malfunctioning of a zone control unit, a malfunctioning of a zone control unit element, and/or a malfunctioning of an inertial measurement unit on a basis of the inertial measurement data fusion.

13. The method according to claim 10, comprising:
calculating a displacement error with regard to a vehicle's center of gravity on a basis of the inertial measurement data fusion.

14. The method according to claim 10, comprising:
selecting inertial measurement data from the current inertial measurement data from the plurality of the zone control units and/or the inertial measurement data fusion for further use in the vehicle and/or in a model of the vehicle.

15. The method according to claim 14, comprising:
regulating a trajectory for the vehicle using the selected inertial measurement data.

16. The method according to claim 14, comprising:
detecting a malfunctioning of at least one of the vehicle, a malfunctioning of vehicle components, a malfunctioning of a zone control unit, a malfunctioning of a zone control unit element, and/or a malfunctioning of an inertial measurement unit on a basis of the selected inertial measurement data.

17. The method according to claim 14, comprising:
calculating a displacement error with regard to a vehicle's center of gravity on a basis of the selected inertial measurement data.

18. The method according to claim 6, wherein an artificial intelligence process is applied to at least one of the steps of the method.

19. A non-transitory computer-readable medium comprising computer program code for carrying out the method according to claim 6.
